(19) United States
(12) Patent Application Publication
(10) Pub. No.: US 2023/0220964 A1
(43) Pub. Date: Jul. 13, 2023

(54) SOLAR FLAME LAMP FOR LAWN

(71) Applicant: WBM LLC, Flemington, NJ (US)

(72) Inventor: SOHAIL ANJUM, FLEMINGTON, NJ (US)

(21) Appl. No.: 17/573,866

(22) Filed: Jan. 12, 2022

(51) Int. Cl. F21S 9/03; F21S 8/08; F21V 19/00; F21V 23/00; F21V 23/04

(52) U.S. Cl. CPC F21S 9/037; F21S 8/081; F21V 19/001; F21V 23/003; F21V 23/04; F21Y 2115/10

(57) ABSTRACT

A solar flame lamp for lawn is provided and includes a lamp body including a lampshade and a lamp pole. A lighting assembly is disposed in the lampshade, the lighting assembly is disposed with a circuit board provided with a control circuit, a power supply and a LED assembly. A lower part of the lampshade is disposed with a lampshade handle connected to the lamp pole through the lampshade handle. The control circuit includes an overcurrent and overvoltage protection circuit, a MCU based controller, a switch control circuit and a driving circuit. The power supply is used to provide power to the MCU based controller through the overcurrent and overvoltage protection circuit, the MCU based controller is used to control the driving circuit through the switch control circuit, and the driving circuit is used to drive the LED assembly to light. It can be automatically controlled, multi-functional and low cost.

### TECHNICAL FIELD

The disclosure relates to the technical field of lighting devices, and more particularly to a solar flame lamp for lawn.

### BACKGROUND

With the development of technology, lighting emitting diode (LED) has more and more applications. The colorful lighting of solar LED lawn lights, courtyard lights and various outdoor lights can make squares, courtyards and other places livelier. Different colors can bring different rendering effects to the surrounding environment.

In addition to the lighting effect, some lamps also have decorative effects. Among many forms of lamps, there is a flame lamp that simulates the jumping and flashing effect of flame combustion. The traditional flame lamp uses a quartz bulb to light up and blow a red silk belt with a fan. The light of the quartz bulb shines on the shaking red silk belt, which looks like a burning flame. However, the fan can bring noise; the silk belt is prone to winding, knotting, damage and other faults. Moreover, the existing flame lamps usually need manual control, which cannot meet the needs of modern automatic control.

### SUMMARY

In view of this, a main objective of the disclosure is to provide a solar flame lamp for lawn with automatic control, diverse functions, simple structure, low cost, flexible and simple operation, safety and reliability.

In order to achieve the above objective of the disclosure, the disclosure provides a solar flame lamp for lawn, which may include a lamp body, and the lamp body may include a lampshade and a lamp pole. A lighting assembly is disposed in the lampshade, the lighting assembly is disposed with a circuit board, a power supply and a LED assembly. The circuit board is disposed with a control circuit, a lower part of the lampshade is disposed with a lampshade handle, and the lampshade is connected to the lamp pole through the lampshade handle.

The control circuit may include an overcurrent and overvoltage protection circuit, a MCU based controller, a switch control circuit and a driving circuit. The power supply is configured to provide power to the MCU based controller through the overcurrent and overvoltage protection circuit, the MCU based controller is configured to control the driving circuit through the switch control circuit, and the driving circuit is configured to drive the LED assembly to light.

In an embodiment, the MCU based controller includes a SCM chip.

In an embodiment, the power supply may include a solar charging circuit, the solar charging circuit may include a solar panel, and the solar panel is arranged on a top of the lampshade.

In an embodiment, the MCU based controller may include a timer, the timer is configured to control the LED assembly to flash at a predetermined interval.

In an embodiment, the switch control circuit may include a key switch.

In an embodiment, the lighting assembly may further include a lamp cover, and the power supply may further include a battery. The LED assembly is a hollow cylindrical, an outer surface of the LED assembly is disposed with a LED array, and the LED assembly is arranged in the lampshade. The battery is arranged in the LED assembly; and the circuit board is arranged at a bottom of the LED assembly. The lamp cover is arranged on a back of the circuit board; and the key switch is arranged on the lamp cover.

In an embodiment, a pressing plate is disposed on the lamp cover, and the key switch is arranged on the pressing plate.

In an embodiment, a waterproof pad is arranged between the pressing plate and the key switch.

In an embodiment, a button cover is disposed on the key switch.

In an embodiment, the lamp pole may include a first connecting tube, a joint, a second connecting tube and an inserting pillar. An end of the first connecting tube is connected to the lampshade handle, another end of the first connecting tube is detachably connected to an end of the joint, and another end of the joint is detachably connected to an end of the second connecting tube. Another end of the second connecting tube is detachably connected to an end of the inserting pillar.

The beneficial effects of the technical solution provided by the disclosure are as follows: (1), the disclosure controls the flashing/lighting of LED assembly through the MCU based controller, with high degree of automation control, simple and flexible operation, safe and reliable use; (2), the disclosure has various functions, simple structure and low cost; and (3), the disclosure has the advantages of detachable assembly, convenient use and maintenance, and is suitable for general promotion.

### BRIEF DESCRIPTION OF DRAWINGS

In order to more clearly explain the embodiments of the disclosure or the technical solutions in the prior art, drawings required to be used in the description of the embodiments or the prior art will be briefly introduced below. It is apparent that the drawings described below are only some embodiments of the disclosure. For those skilled in the art, without paying creative labor, other drawings can also be obtained according to the structures shown in these drawings.

FIG. 1 is a schematic structural diagram of a lampshade of a solar flame lamp for lawn according to an embodiment of the disclosure.

FIG. 2 is a schematic exploded view of a lighting assembly of the solar flame lamp for lawn according to an embodiment of the disclosure.

FIG. 3 is a schematic exploded view of a lamp pole of the solar flame lamp for lawn according to an embodiment of the disclosure.

FIG. 4 is a schematic block diagram showing a control circuit of the solar flame lamp for lawn according to an embodiment of the disclosure.

FIGS. 5A-5C are schematic structural diagrams of a lamp body of the solar flame lamp for lawn according to embodiments of the disclosure.

FIGS. 6A-6C are schematic structural diagrams of another lamp body of the solar flame lamp for lawn according to embodiments of the disclosure.

FIGS. 7A-7C are schematic structural diagrams of further another lamp body of the solar flame lamp for lawn according to embodiments of the disclosure.

FIGS. 8A-8C are schematic structural diagrams of still another lamp body of the solar flame lamp for lawn according to embodiments of the disclosure.

FIG. 9 is a schematic structural diagram of a LED assembly of the solar flame lamp for lawn according to an embodiment of the disclosure.

FIG. 10 is a schematic structural diagram of another LED assembly of the solar flame lamp for lawn according to an embodiment of the disclosure.

### DESCRIPTION OF REFERENCE NUMERALS

1—solar panel, 2—lighting assembly, 3—lamp pole, 4—lampshade, 5—circuit board, 6—lamp cover, 7—switch assembly, 8—LED assembly, 9—battery sleeve, 10—power supply, 101—battery, 11—pressing plate, 12—waterproof pad, 13—switch, 14—button cover, 15—first connecting tube, 16—joint, 17—second connecting tube, 18—inserting pillar, 181—inserting bump, 19—gasket, 20—overcurrent and overvoltage protection circuit, 21—first lamp housing, 22—second lamp housing, 201—first lamp handle, 202—second lamp handle, 30—MCU based controller, 301—timer, 40—switch control circuit, 50—driving circuit, 60—solar charging circuit.

### DETAILED DESCRIPTION OF EMBODIMENTS

The technical solutions in the embodiments of the disclosure will be clearly and completely described below in combination with the accompanying drawings in the embodiments of the disclosure. Apparently, the described embodiments are only some of embodiments of the disclosure, not all of embodiments of the disclosure. Based on the illustrated embodiments of the disclosure, all other embodiments obtained by those skilled in the art without creative work belong to the protection scope of the disclosure.

It should be noted that in the illustrated embodiments of the disclosure, all directional indications (such as up, down, left, right, front, rear . . . ) are only used to explain relative position relationships and motions between components under specific situations (as shown in the accompanying drawings). If the specific situations change, the directional indications will change accordingly.

In the disclosure, unless otherwise clearly specified and defined, the terms “connect”, “fixedly” etc. should be understood in a broad sense. For example, “fixedly” can be a fixed connection, a detachable connection or an integral (one-piece) structure; it can be mechanical connection or electrical connection; it can be direct connection or indirect connection through an intermediate medium; it can be an internal communication between two components or an interaction relationship between two components, unless otherwise clearly defined. For those skilled in the art, specific meanings of the above terms in the disclosure can be understood according to specific situations.

In addition, in the disclosure, the description of “first”, “second”, etc. is only for descriptive purposes, and cannot be understood as indicating or implying their relative importance or implicitly indicating the number of indicated technical features. Thus, the features defined with “first” and “second” may explicitly or implicitly include at least one of the features. In addition, the technical solutions between various embodiments can be combined with each other, but it must be based on the realization of those skilled in the art. When the combination of technical solutions is contradictory or impossible, it shall be considered that the combination of technical solutions does not exist and is not within the protection scope of the disclosure.

Specifically, the disclosure provides a solar flame lamp for lawn.

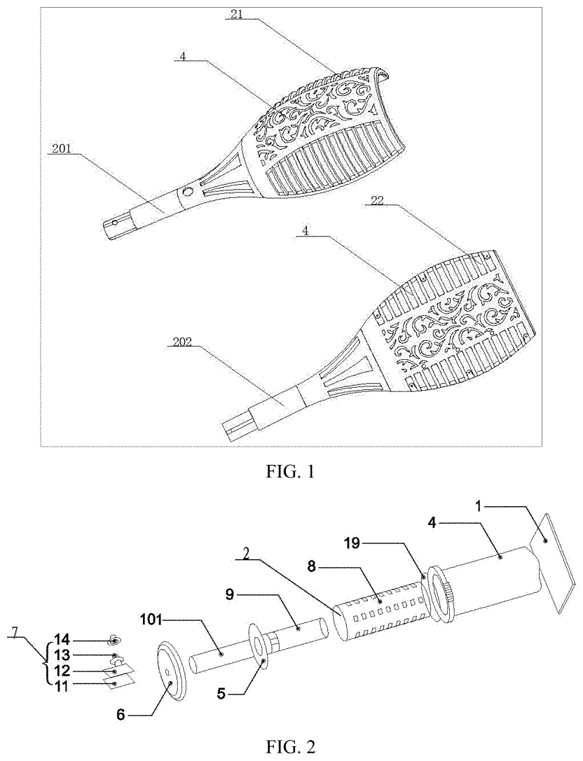

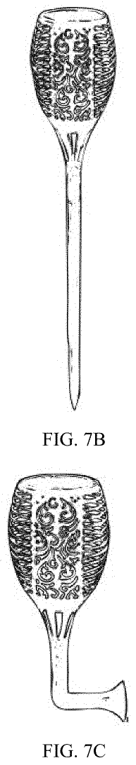

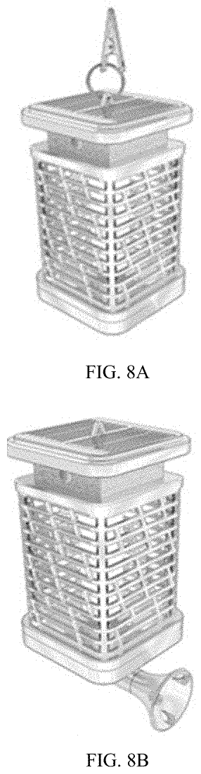

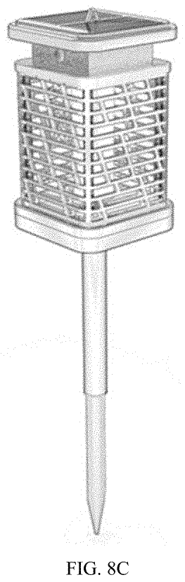

Referring to FIGS. 1 through 10, in an embodiment of the disclosure, the solar flame lamp for lawn may include a lamp body, and the lamp body may include a lampshade 4 and a lamp pole 3. A lighting assembly 2 is arranged in the lampshade 4. The lighting assembly 2 may include a power supply 10, a circuit board 5, and a LED assembly 8. A control circuit is arranged on the circuit board 5. In the illustrated embodiment, the lampshade 4 may include a first lamp housing 21 and a second lamp housing 22. The first lamp housing 21 and the second lamp housing 22 are corresponded to each other in size and shape, and the first lamp housing 21 and the second lamp housing 22 are buckled together to form the lampshade 4. A lower part of the first lamp housing 21 is disposed with a first lamp handle 201, and a lower part of the second lamp housing 22 is disposed with a second lamp handle 202. The first lamp handle 201 and the second lamp handle 202 are corresponded to each other in size and shape, and the first lamp handle 201 and the second lamp handle 202 are buckled together to form a lampshade handle. The lamp pole 3 is inserted into the lampshade handle, and the lampshade 4 is connected to the lamp pole 3 through the lampshade handle.

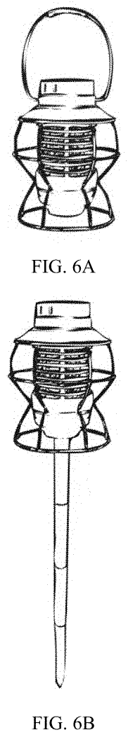

Referring to FIG. 4, the control circuit may include an overcurrent and overvoltage protection circuit 20, a microcontroller unit (MCU) based controller 30, a switch control circuit 40, and a driving circuit 50. The power supply 10 is configured (i.e., structured and arranged) to supply power to the MCU based controller 30 through the overcurrent and overvoltage protection circuit 20. The MCU based controller 30 is configured to control the driving circuit 50 through the switch control circuit 40, and the driving circuit 50 is configured to drive the LED assembly 8 to light, e.g., flash.

In an illustrated embodiment, the overcurrent and overvoltage protection circuit 20 is configured to prevent the overcurrent and overvoltage of circuit in the power supply and plays a role of safety protection.

In an illustrated embodiment, the MCU based controller 30 includes a single-chip microcomputer (SCM) chip.

In an illustrated embodiment, the power supply 10 may include a battery 101.

In an illustrated embodiment, the switch control circuit 40 may include a key switch 13.

In an illustrated embodiment, the power supply 10 may include a solar charging circuit 60, the solar charging circuit 60 may include a solar panel 1, and the solar panel is arranged on a top of the lampshade 4. The solar charging circuit 60 is used to charge through the solar panel 1 for power supply.

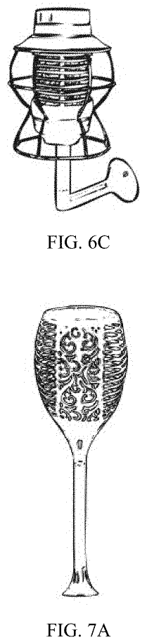

Referring to FIGS. 5A-5C, FIGS. 6A-6C, FIGS. 7A-7C and FIGS. 8A-8C, in various illustrated embodiments, a shape of the lampshade 4 may include one selected from a group consisting of a cylindrical shape, a spherical shape, a combined shape of a hemispherical shape at an upper part and a cylindrical shape at a lower part, and a regular polyhedron shape. Preferably, a shape of the top of the lampshade 4 includes one selected from a group consisting of a semicircular sphere, a tetrahedral platform, a pentahedral platform, a hexahedral platform, an octahedral platform, a decahedral platform and a plum blossom platform.

In an illustrated embodiment, the MCU based controller 30 may include a timer 301 and the timer 301 is configured for timing control of flashing of the LED assembly (i.e., controlling the LED assembly to flash at a predetermined interval).

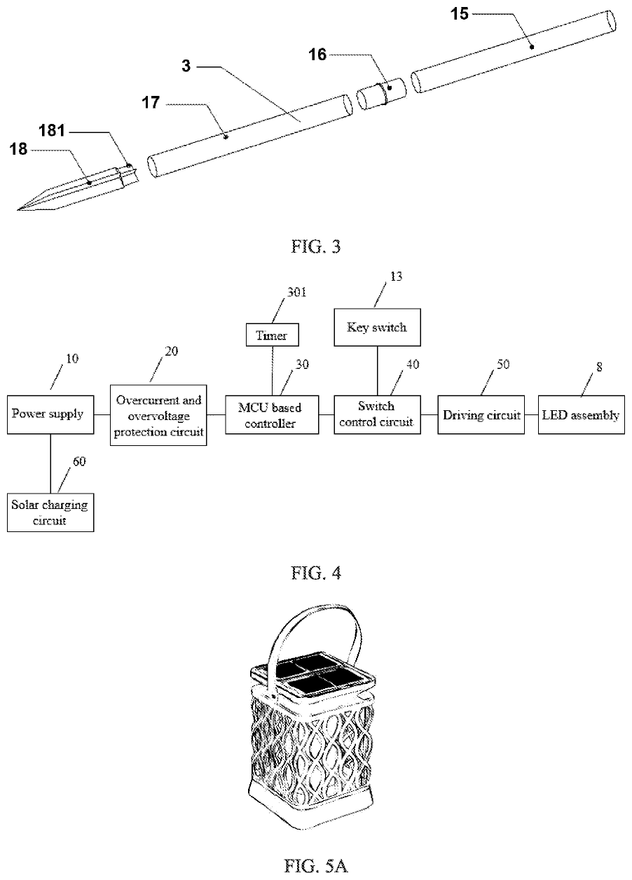

Referring to FIG. 2, in the illustrated embodiment, the lighting assembly 2 may include the LED assembly 8, the battery 101, the circuit board 5 and a lamp cover 6. The LED assembly 8 is hollow cylindrical, an outer surface of the LED assembly 8 is disposed with a LED array, and the LED assembly 8 is arranged in the lampshade 4. The battery 101 is arranged in the LED assembly 8, and the circuit board 5 is arranged at a bottom of the LED assembly 8. The battery 101 is connected to the circuit board 5. The lamp cover 6 is arranged on a back (e.g., rear side) of the circuit board 5, and the key switch 13 is arranged/disposed on the lamp cover 6.

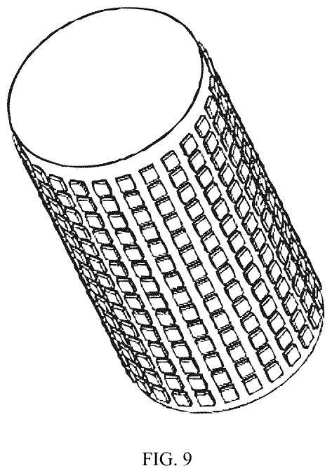

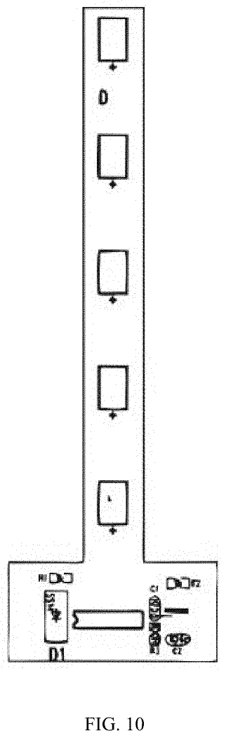

Referring to FIG. 9 and FIG. 10, FIG. 9 and FIG. 10 show two different structures of the LED assembly. The LED assembly 8 can display different flame shapes through the control of the MCU based controller 30, making the disclosure more beautiful.

In an illustrated embodiment, the battery 101 may be disposed with a battery sleeve 9, the battery 101 is arranged in the battery sleeve 9, and the battery sleeve 9 is arranged in the LED assembly 8. The battery sleeve 9 is configured to protect the battery 101 and prolong the service life of the battery 101.

In the illustrated embodiment, the LED assembly 8 is arranged in the lampshade 4, the battery 101 is arranged in the LED assembly 8, the battery 101 is connected to the circuit board 5, the back of the circuit board 5 is disposed with the lamp cover 6, and the lamp cover 6 is buckled at the bottom of the lampshade 4. Preferably, a gasket 19 is arranged between the lamp cover 6 and the bottom of the lampshade 4, so that the lamp cover 6 and the lampshade 4 are more closely connected, safe and reliable.

In an illustrated embodiment, a pressing plate 11 is arranged/disposed on the lamp cover 6, and the key switch 13 is arranged on the pressing plate 11. The pressing plate 11 is arranged between the key switch 13 and the lamp cover 6 to play a safety protection role.

In an illustrated embodiment, a waterproof pad/gasket 12 is arranged between the pressing plate 11 and the key switch 13. The waterproof pad 12 prevents water from entering the lamp for lawn when it is placed in the open air and protects the key switch 13.

In an illustrated embodiment, the key switch 13 is disposed with a button cover 14. The button cover 14 is configured to protect and assist the key switch 13.

The pressing plate 11, the waterproof pad 12, the key switch 13 and the button cover 14 may together constitute a switch assembly 7.

The key switch 11 can control different flashing of the LED assembly 8, so that when the LED assembly 8 flashes, there are different forms of flame to display, which has beautiful effects and is deeply loved by consumers.

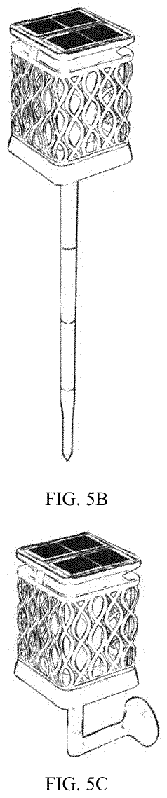

Referring to FIG. 3, in an illustrated embodiment, the lamp pole 3 may include a first connecting tube 15, a joint (also referred to as connector) 16, a second connecting tube 17 and an inserting pillar 18. An end of the first connecting tube 15 is connected to the lampshade handle, another end is detachably connected to an end of the joint 16, and another end of the joint 16 is detachably connected to an end of the second connecting tube 17. Another end of the second connecting tube 17 is detachably connected to an end of the inserting pillar 18.

In an illustrated embodiment, an end of the inserting pillar 18 is disposed with an inserting bump 181, and the inserting pillar 18 is connected to the second connecting tube 17 through the inserting bump 181. In this way, the inserting pillar 18 is more closely connected to the second connecting tube 17 and is not easy to loosen, which ensures the safety of the disclosure and more stable use.

In an illustrated embodiment, an end of the inserting pillar 18 is tip-shaped and suitable for being inserted into the lawn. The inserting pillar 18 is connected to the first connecting tube 15 through the second connecting tube 17 and the joint 16 to form the lamp pole 3. The lamp pole of the disclosure may have the advantages of convenient disassembly and installation, more flexible use and simple maintenance.

The circuit of the disclosure has high intelligence, and thus can make the LED assembly display more flame patterns. Moreover, the disclosure may have a simple and firm structure, be convenient for installation and production, and also have good waterproof effect.

The above is only preferred embodiments of the disclosure and does not limit the protection scope of the disclosure. On the premise of not departing from the spirit and scope of the disclosure, the disclosure will have various changes and modifications. All equivalent structural transformations made by using the description and accompanying drawings of the disclosure under the inventive concept of the disclosure, or directly/indirectly applied in other relevant technical fields are included in the protection scope of the disclosure.

1. A solar flame lamp for lawn, comprising a lamp body, wherein the lamp body comprises a lampshade and a lamp pole;
wherein a lighting assembly is disposed in the lampshade, the lighting assembly is disposed with a circuit board, a power supply, and a hollow light emitting diode (LED) assembly; the circuit board is disposed with a control circuit, a lower part of the lampshade is disposed with a lampshade handle, the lampshade is connected to the lamp pole through the lampshade handle, and an outer surface of the hollow LED assembly is disposed with a LED array;
wherein the control circuit comprises: an overcurrent and overvoltage protection circuit, a microcontroller unit (MCU) based controller, a switch control circuit, and a driving circuit;
wherein the power supply is configured to provide power to the MCU based controller through the overcurrent and overvoltage protection circuit, the MCU based controller is configured to control the driving circuit through the switch control circuit, and the driving circuit is configured to drive the hollow LED assembly to light;
wherein the power supply comprises a battery and a solar charging circuit, the battery is sleeved with a battery sleeve and connected to the circuit board, the battery and the battery sleeve both are disposed inside the hollow LED assembly, the solar charging circuit comprises a solar panel, and the solar panel is arranged on a top of the lampshade; the circuit board is arranged at a bottom of the hollow LED assembly, and a lamp cover of the lighting assembly is arranged on a back of the circuit board and buckled at a bottom of the lampshade.

2. The solar flame lamp for lawn according to claim 1, wherein the MCU based controller comprises a single-chip microcomputer (SCM) chip.

3. (canceled)

4. The solar flame lamp for lawn according to claim 1, wherein the MCU based controller comprises a timer, and the timer is configured to control the LED assembly to flash at a predetermined interval.

5. The solar flame lamp for lawn according to claim 4, wherein the switch control circuit comprises a key switch.

6. The solar flame lamp for lawn according to claim 5, wherein the key switch is arranged on the lamp cover.

7. The solar flame lamp for lawn according to claim 6, wherein a pressing plate is disposed on the lamp cover, and the key switch is arranged on the pressing plate.

8. The solar flame lamp for lawn according to claim 7, wherein a waterproof pad is arranged between the pressing plate and the key switch.

9. The solar flame lamp for lawn according to claim 8, wherein a button cover is disposed on the key switch.

10. The solar flame lamp for lawn according to claim 9, wherein the lamp pole comprises: a first connecting tube, a joint, a second connecting tube, and an inserting pillar;
wherein an end of the first connecting tube is connected to the lampshade handle, another end of the first connecting tube is detachably connected to an end of the joint, another end of the joint is detachably connected to an end of the second connecting tube; and another end of the second connecting tube is detachably connected to an end of the inserting pillar.

11. A solar flame lamp for lawn, comprising:
a lampshade;
a lamp pole, connected to the lampshade;
a lighting assembly, disposed in the lampshade and comprising a circuit board, a power supply, a hollow LED assembly, and a lamp cover;
wherein an outer surface of the hollow LED assembly is disposed with a LED array, the power supply is configured to provide power to the circuit board, and the circuit board is configured to drive the hollow LED assembly to light;
wherein the power supply comprises a battery and a solar panel, the battery is sleeved with a battery sleeve and connected to the circuit board, the battery and the battery sleeve both are disposed inside the hollow LED assembly, and the solar panel is arranged on a top of the lampshade; the circuit board is arranged at a bottom of the hollow LED assembly, and the lamp cover of the lighting assembly is arranged on a back of the circuit board and connected at a bottom of the lampshade;
wherein the circuit board is disposed with a switch assembly, and the switch assembly comprises a pressing plate, a waterproof pad, a key switch, and a button cover arranged sequentially in that order on the lamp cover.

12. The solar flame lamp for lawn according to claim 11, wherein a gasket is arranged between the lamp cover and the bottom of the lampshade.
